(19) United States
(12) Patent Application Publication
(10) Pub. No.: US 2018/0254881 A1
(43) Pub. Date: Sep. 6, 2018

(54) METHOD FOR COMPENSATING A DELAYED SIGNAL

(71) Applicant: MICROELECTRONICS TECHNOLOGY, INC., Hsinchu (TW)

(72) Inventor: SHUEN-JENG LIN, HSINCHU (TW)

(21) Appl. No.: 15/448,000

(22) Filed: Mar. 2, 2017

(51) Int. Cl. H04L 7/00; H04L 7/04

(52) U.S. Cl. CPC H04L 7/0041; H04L 7/04

(57) ABSTRACT

A method includes transmitting a first signal, including a first unique data, from a first transceiver device; marking a timing at which the first unique data in the first signal is exhibited as a first timing; receiving a second delayed signal, including a second unique data, at a first transceiver device, the second delayed signal being delayed from a second signal, and the second signal being transmitted from a second transceiver device; marking a timing at which the second unique data in the second delayed signal is exhibited as a second timing; and compensating, based on the first timing and the second timing, a delayed source signal received by the second transceiver device, the delayed source signal being delayed from a source signal received and transmitted by the first transceiver device.

### TECHNICAL FIELD

The present disclosure relates to a method, and more particularly, to a method for compensating a delayed signal.

### DISCUSSION OF THE BACKGROUND

Wired or wireless communications are widely applied to pairs of transceiver devices, communicating with each other. For wireless communications, complex modulation techniques such as Amplitude Modulation (AM) and Phase Modulation (PM) with broad spectrums in a code domain multiplex are widely used in new wireless communication systems. For example, Code Division Multiple Access (CDMA) and Wideband Code Division Multiple Access (WCDMA) are used in 3G wireless communication systems, and Orthogonal frequency-division multiplexing (OFDM) is used in Long Term. Evaluation (LTE) wireless communication systems. However, the transmission delay issue will inevitably occur regardless of the selected method of wired or wireless communication.

This Discussion of the Background section is provided for background information only. The statements in this Discussion of the Background are not an admission that the subject matter disclosed in this section constitutes prior art to the present disclosure, and no part of this section may be used as an admission that any part of this application, including this Discussion of the Background section, constitutes prior art to the present disclosure.

### SUMMARY

One aspect of the present disclosure provides a method. The method includes transmitting a first signal, including a first unique data, from a first transceiver device; marking a timing at which the first unique data in the first signal is exhibited as a first timing; receiving a second delayed signal, including a second unique data, at a first transceiver device, the second delayed signal being delayed from a second signal, and the second signal being transmitted from a second transceiver device; marking a timing at which the second unique data in the second delayed signal is exhibited as a second timing; and compensating, based on the first timing and the second timing, a delayed source signal received by the second transceiver device, the delayed source signal being delayed from a source signal received and transmitted by the first transceiver device.

In some embodiments, marking the timing at which the first unique data in the first signal is exhibited as the first timing includes counting to a first number by a first counter when the first unique data in the first signal is exhibited, and marking the timing at which the second unique data in the second delayed signal is exhibited as the second timing includes counting to a second number by the first counter when the second unique data, in the second delayed signal, is exhibited.

In some embodiments, compensating, based on the first timing and the second timing, the delayed source signal received by the second transceiver device includes compensating, based on the first number and the second number counted by the first counter, the delayed source signal.

In some embodiments, the method further includes receiving a first delayed signal, including the first unique data, at a second transceiver device, the first delayed signal being delayed from the first signal; marking a timing at which the first unique data in the first delayed signal is exhibited as a third timing; transmitting the second signal, including the second unique data, from the second transceiver device; marking a timing at which the second unique data in the second signal is exhibited as a fourth timing; and compensating, based on the first timing and the second timing, the delayed source signal received by the second transceiver device further including compensating, based on the first timing, the second timing, the third timing and the fourth timing, the delayed source signal.

In some embodiments, marking the timing at which the first unique data in the first delayed signal is exhibited as the third timing includes counting to a third number by a second counter when the first unique data in the first delayed signal is exhibited, and marking the timing at which the second unique data in the second signal is exhibited as the fourth timing includes counting to a fourth number by the second counter when the second unique data in the second signal is exhibited.

In some embodiments, compensating, based on the first timing and the second timing, the delayed source signal received by the second transceiver device includes compensating, based on the third number and the fourth number counted by the second counter, the first timing and the second timing, the delayed source signal.

In some embodiments, the method further includes storing the third timing and the fourth timing on the second transceiver device; transmitting the first timing from the first transceiver device to the second transceiver device; transmitting the second timing from the first transceiver device to the second transceiver device; and obtaining, based on the first timing, the second timing, the third timing and the fourth timing, a phase difference determined by the second transceiver device; and compensating, based on the first timing, the second timing, the third timing and the fourth timing, the delayed source signal including compensating, based on the phase difference, a delayed source signal by the second transceiver device.

In some embodiments, the method further includes storing the first timing and the second timing at the first transceiver device; transmitting the third timing and the fourth timing from the second transceiver device to the first transceiver device; obtaining, based on the first timing, the second timing, the third timing and the fourth timing, a phase difference determined by the first transceiver device; transmitting the phase difference from the first transceiver device to the second transmission; and compensating, based on the first timing, the second timing, the third timing and the fourth timing, the delayed source signal including compensating, based on the phase difference, a delayed source signal by the second transceiver device.

Another aspect of the present disclosure provides a method. The method includes performing a first operation including an operation for obtaining a phase difference as a first phase difference, and obtaining a phase difference as a second phase difference; performing a second operation including the operation for obtaining a phase difference as a second phase difference; and repeating the first and second operations until a difference between the first phase difference and the second phase difference is smaller than a threshold value. The operation includes transmitting a first signal, including a first unique data, from a first transceiver device; marking a timing at which the first unique data in the first signal is exhibited as a first timing; receiving a second delayed signal, including a second unique data, at a first transceiver device, the second delayed signal being delayed from a second signal, and the second signal being transmitted from a second transceiver device; marking a timing at which the second unique data in the second delayed signal is exhibited as a second timing; and obtaining the phase difference based on the first timing, the second timing, the third timing and the fourth timing.

In some embodiments, the method further includes obtaining an optimal phase difference when halting the first operation and the second operation; and compensating, based on the optimal phase difference, a delayed source signal received by the second transceiver device, the delayed source signal being delayed from a source signal received and transmitted by the first transceiver device.

In some embodiments, marking the timing at which the first unique data in the first signal is exhibited as the first timing includes counting to a first number by a first counter when the first unique data in the :first signal is exhibited, and marking the timing at which the second unique data in the second delayed signal is exhibited as the second timing includes counting to a second number by the first counter when the second unique data, in the second delayed signal, is exhibited.

In some embodiments, compensating, based on the optimal phase difference, a delayed source signal includes compensating, based on the first number and the second number counted by the first counter, the delayed source signal.

Another aspect of the present disclosure provides a system. The system includes a first transceiver device, a first counter and a second transceiver device. The first transceiver device is configured to receive and transmit a source signal, transmit a first signal including a first unique data, and receive a second delayed signal, including a second unique data, the second delayed signal being delayed from a second signal. The first counter is configured to mark a timing at which the first unique data in the first signal is exhibited as a first timing, and to mark a timing at which the second unique data in the second delayed signal is exhibited as a second timing. The second transceiver device is configured to transmit the second signal including the second unique data, receive a delayed source signal, the delayed source signal being delayed from the source signal, and compensate, based on the first timing and the second timing, the delayed source signal.

In some embodiments, the first transceiver device is independent of and separate from the second transmission by a distance.

In some embodiments, the first counter is integrated in the first transceiver device.

In some embodiments, the first counter is further configured to count to a first number when the first unique data in the first signal is exhibited, and to count to a second number when the second unique data, in the second delayed signal, is exhibited.

In some embodiments, the second transceiver device is configured to compensate, based on the first number and the second number counted by the first counter, the delayed source signal.

In some embodiments, the second transmission is configured to receive a first delayed signal including the first unique data, the first delayed signal being delayed from the first signal, transmit the second signal including the second unique data, and compensate, based on the first timing, the second timing, a third timing and a fourth timing, the delayed source signal. The system further includes a second counter configured to mark a timing at which the first unique data in the first delayed signal is exhibited as a third timing, and to mark a timing at which the second unique data in the second signal is exhibited as a fourth timing.

In some embodiments, the second counter is configured to count to a third number when the first unique data in the first delayed signal is exhibited, and to count to a fourth number when the second unique data in the second signal is exhibited.

In some embodiments, the second transceiver device is configured to compensate, based on the third and fourth numbers, which are counted by the second counter, and the first timing and the second timing, the delayed source signal.

Compared to some prior approaches, the present disclosure presents not only a method of compensating a source signal, but also a method for better compensating the source signal. Moreover, by applying the method of the present disclosure into the system, a signal provided by the second transceiver device 104 is synchronized with the first transceiver device 102. Additionally, there is no need to provide two counters whose functions are completely the same. The method of the present disclosure can function effectively even with two counters having different functions. As a result, the present disclosure provides flexibility in the design of its two counters.

The foregoing has outlined rather broadly the features and technical advantages of the present disclosure in order that the detailed description of the disclosure that follows may be better understood. Additional features and advantages of the disclosure are described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a block diagram of a system in accordance with some embodiments of the present disclosure.

FIG. 2 is a flow chart illustrating a method of compensating the source signal shown in FIG. 1 in accordance with some embodiments of the present disclosure.

FIG. 3 is a timing diagram of illustrative signals corresponding to the system shown in FIG. 1 in accordance with some embodiments of the present disclosure.

FIG. 4 illustrates interaction of the system shown in FIG. 1 in accordance with some embodiments of the present disclosure.

FIG. 5 illustrates interaction of the system shown in FIG. 1 in accordance with some embodiments of the present disclosure.

FIG. 6 is a flow chart illustrating a method of compensating the source signal shown in FIG. 1 in accordance with some embodiments of the present disclosure.

### DETAILED DESCRIPTION

Embodiments, or examples, of the disclosure illustrated in the drawings are now described using specific language. It shall be understood that no limitation of the scope of the disclosure is thereby intended. Any alteration or modification to the described embodiments, and any further applications of principles described in this document, are to be considered as normally occurring to one of ordinary skill in the art to which the disclosure relates. Reference numerals may be repeated throughout the embodiments, but this does not necessarily require that feature(s) of one embodiment apply to another embodiment, even if they share the same reference numeral.

It shall be understood that when an element is referred to as being “connected to” or “coupled with” another element, it may be directly connected to or coupled to the other element, or intervening elements may be present.

It shall be understood that, although the terms first, second, third, etc. may be used herein to describe various elements, components, regions, layers or sections, these elements, components, regions, layers or sections should not be limited by these terms. Rather, these terms are merely used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It shall be further understood that the terms “comprises” and “comprising,” when used in this specification, specify the presence of stated features, integers, steps, operations, elements, or components, but do not preclude the presence or addition of one or more other features, integers, steps, operations, elements, components, or groups thereof.

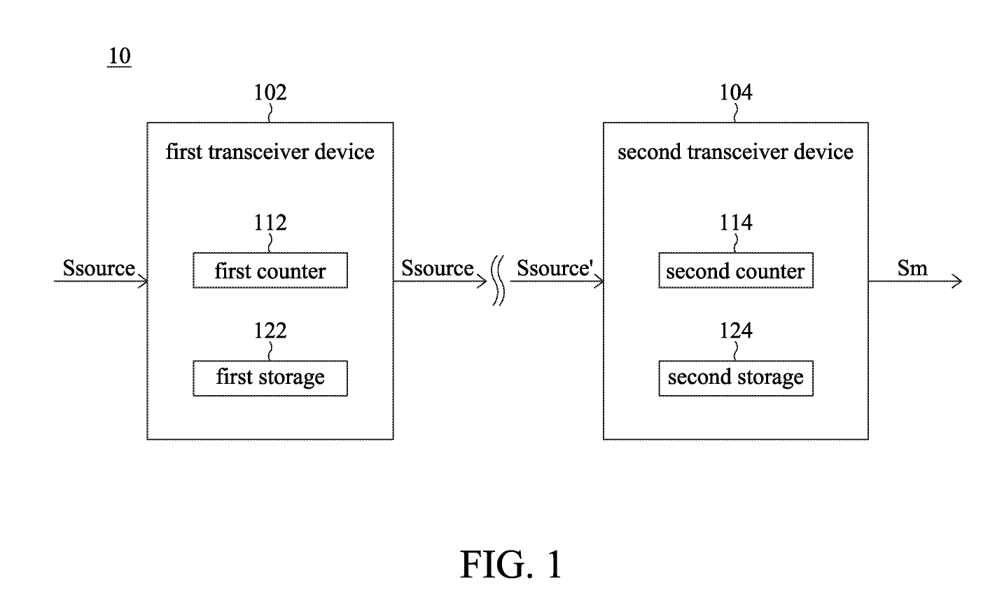

FIG. 1 is a block diagram of a system 10 in accordance with some embodiments of the present disclosure. Referring to FIG. 1, the system 10 includes a first transceiver device 102 and a second transceiver device 104. The first transceiver device 102 is independent of the second transceiver device 104, and separate from the second transceiver device 104 by a distance. For example, the first transceiver device 102 is placed on a mountain, and the second transceiver device 104 is placed on another mountain. The first transceiver device 102 can wirelessly communicate with the second transceiver device 104, or can communicate with the second transceiver device 104 using a wire.

The first transceiver device 102 functions to receive a source signal Ssource from a source such as a source generator or a radio station, and transmit the source signal Ssource to the second transceiver device 104. In an embodiment, the first transceiver device 102 includes a radio station.

The second transceiver device 104 functions to receive a delayed source signal Ssource′, compensate the delayed source signal Ssource′, and provides a compensated signal Sm. The compensated signal Sm in phase is substantially the same as the source signal Ssource. In an embodiment, the second transceiver device 104 includes a radio station.

In further detail, the delayed source signal Ssource′ is delayed from the source signal Ssource. For example, during the transmission of the source signal Ssource, a phase shift may occur due to, for example, an effect of a transmission channel, such that the source signal Ssource is delayed and becomes the delayed source signal Ssource′. Accordingly, the source signal Ssource is not synchronized with the delayed source signal Ssource′.

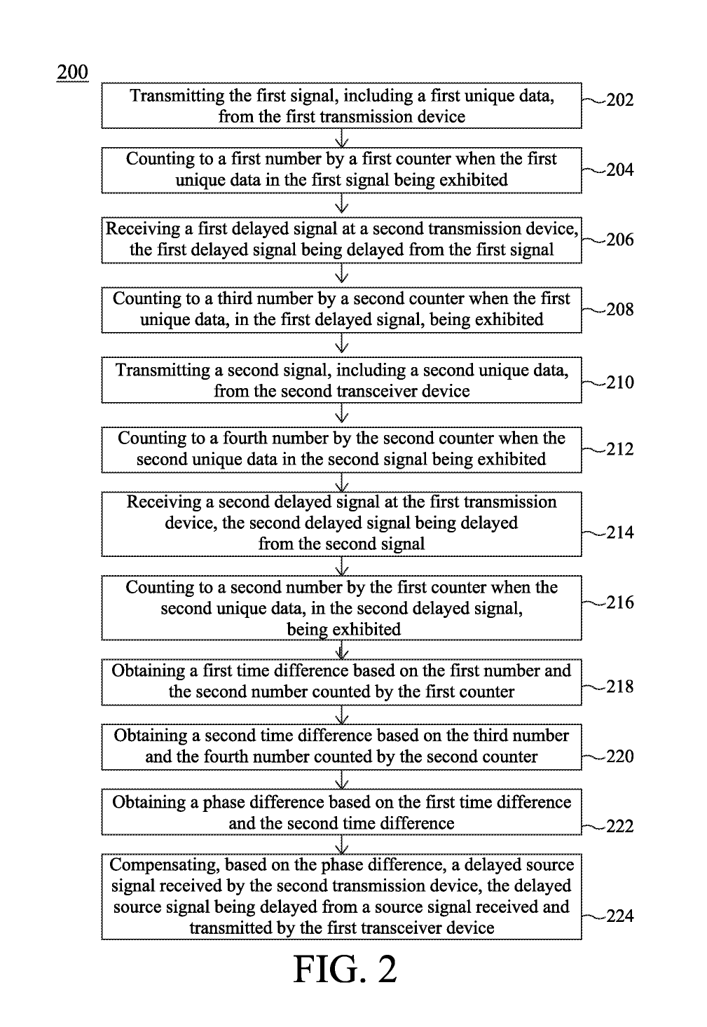

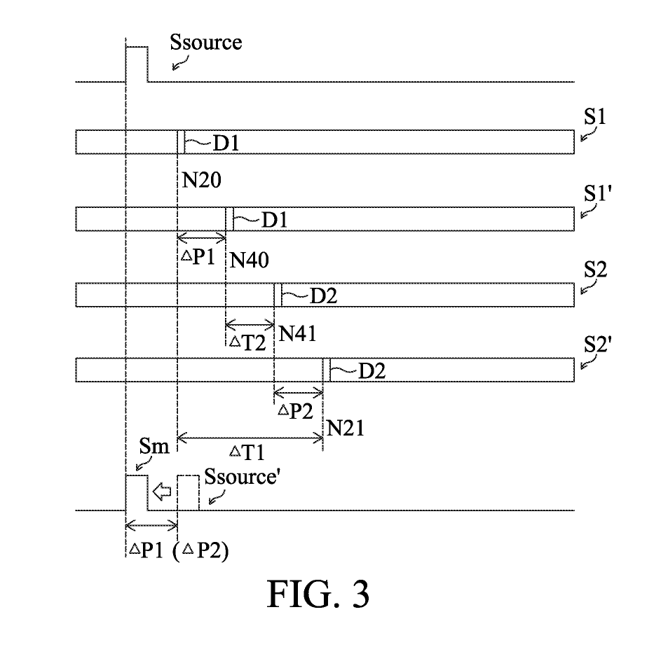

The first transceiver device 102 includes a first counter 112 and a first storage 122, which are used to compensate the delayed source signal Ssource′ and will be discussed in detail with reference to FIGS. 2 and 3. The first counter 112 has a first period, such as 8 nanoseconds (ns). That is to say, the first counter 112 adds 1 to its count every 8 nanoseconds. For example, at time t0 the counted number is 100, and at time (t0+8 ns) the counted number is 101.

Additionally, the first counter 112 may be integrated in the first transceiver device 102, or external to the first transceiver device 102. Moreover, the first counter 122 may be implemented using logic gates.

In some embodiments, the first storage 112 includes read, random access memory (RAM), dynamic random access memory (DRAM), static random access memory (SRAM), logical gate arrays, or another static storage device.

The second transceiver device 104 includes a second counter 114 and a second storage 124, which are used to compensate the delayed source signal Ssource′ and will be discussed in detail with reference to FIGS. 2 and 3. The second counter 114 has a second period, such as 8 ns. That is to say, the second counter 114 adds 1 to its count every 8 ns. For example, at time t0 the counted number is 100, and at time (t0+8 ns) the counted number is 101. In an embodiment, the second period is the same as the first period. In another embodiment, the second period is different from the first period. For example, the first counter 112 adds 1 to its count every 8 nanoseconds, while the second counter 114 adds 1 to its count every 9 nanoseconds.

Additionally, the second counter 114 may be integrated in the second transceiver device 104, or external to the second transceiver device 104. Moreover, the second counter 114 may be implemented using logic gates.

In some embodiments, the second storage 124 includes random access memory (RAM), dynamic random access memory (DRAM), static random access memory (SRAM), logical gate arrays, or another static storage device.

FIG. 2 is a flow chart illustrating a method 200 of compensating the source signal Ssource shown in FIG. 1 in accordance with some embodiments of the present disclosure. FIG. 3 is a timing diagram of illustrative signals corresponding to the system shown in FIG. 1 in accordance with some embodiments of the present disclosure. Referring to FIG. 2, the method 200 begins with operation 202, in which, also referring to FIG. 3, a first signal S1, including a first unique data D1, is transmitted from the first transceiver device 102. The first unique data D1 is different from other data in the first signal S1, and accordingly can serve as an identifier. In an embodiment, the first signal S1 is generated by the first transceiver device 102. In an embodiment, the first signal S1 includes any suitable type of signal, such as a frame signal.

The method 200 then continues with operation 204, in which the first counter 112 marks a timing at which the first unique data D1 in the first signal S1 is exhibited as a first timing. In an embodiment, the first counter 112 counts to a first number N20 representing the first timing when the first unique data in the first signal is exhibited.

The method 200 proceeds with operation 206, in which, also referring to FIG. 3, the second transceiver device 104 receives a first delayed signal. S1′. For reasons similar to those in the discussion regarding the delay of the source signal Ssource, the first delayed signal S1′ is delayed from the first signal S1.

The method 200 proceeds with operation 208, in which the second counter 114 marks a timing at which the first unique data D1 in the first delayed signal S1′ is exhibited as a third timing. In an embodiment, the second counter 114 counts to a third number N40 representing the third timing when the first unique data D1 in the first delayed signal S1′ is exhibited. As illustrated in FIG. 3, there is a difference ΔP1 between the first number N20 and the third number N40. Since the first number N20 and the third number N40 are obtained by different counters, it is not possible to determine the exact value of the difference ΔP1 in the time domain. The difference ΔP1 indicates a transmission delay from the first transceiver device 102 to the second transceiver device 104. It should be noted that since the second counter 114 in period may be different from the first counter 112, even if the third number N40 is equal to the first number N20, such circumstance does not indicate that no delay exists.

In operation 210, also referring to FIG. 3, the second transceiver device 104 transmits a second signal S2 including a second unique data D2. The second unique data D2 may be the same as or different from the first unique data D1. The second unique data D2 is different from other data in the second signal S2, and accordingly can serve as an identifier. In an embodiment, the second signal S2 is generated by the second transceiver device 104. In an embodiment, the second signal S2 includes any suitable type of signal, such as a frame signal.

Subsequently, the method 200 continues with operation 212, in which, referring to FIG. 3, the second counter 114 marks a timing at which the second unique data D2 in the second signal S1 is exhibited as a fourth timing. In an embodiment, the second counter 114 counts to a fourth number N41 when the second unique data D2 in the second signal S2 is exhibited.

The method 200 proceeds with operation 214, in which the first transceiver device 102 receives a second delayed signal S2′ including the second unique data D2. For reasons similar to those in the discussion regarding the delay of the source signal Ssource, the second delayed signal S2′ is delayed from the first signal S2.

The method 200 proceeds with operation 216, in which the first counter 112 marks a timing at which the second unique data D2 in the second delayed signal S2′ is exhibited as a second timing. In an embodiment, the first counter 112 counts to a second number N21 when the second unique data D2, in the second delayed signal S2′, is exhibited.

As illustrated in FIG. 3, there is a difference ΔP2 between the fourth number N41 and the second number N21. The difference ΔP2 indicates a transmission delay from the second transceiver device 104 to the first transceiver device 102. However, since both ΔP1 and ΔP2 represent the transmission delay between the first transceiver device 102 and the second transceiver device 104, the difference ΔP2 is the same as the difference ΔP1. Moreover, since the fourth number N41 is and the second number N21 are obtained by different counters, it is not possible to determine the exact value of the difference ΔP2 in the time domain.

After obtaining the first timing, the second timing, the third timing and the fourth timing, the method 200 continues with operations 218 and 220. In operation 218, since the first number N20 and the second number N21 are both obtained by means of the same first counter 112, a first time difference ΔT1 based on the first number N20 and the fourth number N21 counted by the first counter 112 is obtained. The first time difference ΔT1 can be expressed in equation (1) below.

ΔT1=(N21−N20)×T1 (1)

Where T1 represents the first period.

According to equation (1), it is assumed that the first period of the first counter 112 is 8 ns; the first number N20 is 100; and the second number N21 is 200. As a result, the first time difference ΔT1 is 800 ns.

In operation 220, since the third number. N40 and the fourth number N41 are both obtained by means of the same second counter 114, a second time difference ΔT2 based on the third number N40 and the fourth number N41 counted by the second counter 114 is obtained. The second time difference can be expressed in equation (2) below.

ΔT2=(N41−N40)×T2 (2)

Where T2 represents the second period.

According to equation (2), it is assumed that the second period T2 of the second counter 114 is 8 ns; the third number N40 is 100; and the fourth number N41 is 150. As a result, the second time difference ΔT2 is 400 ns.

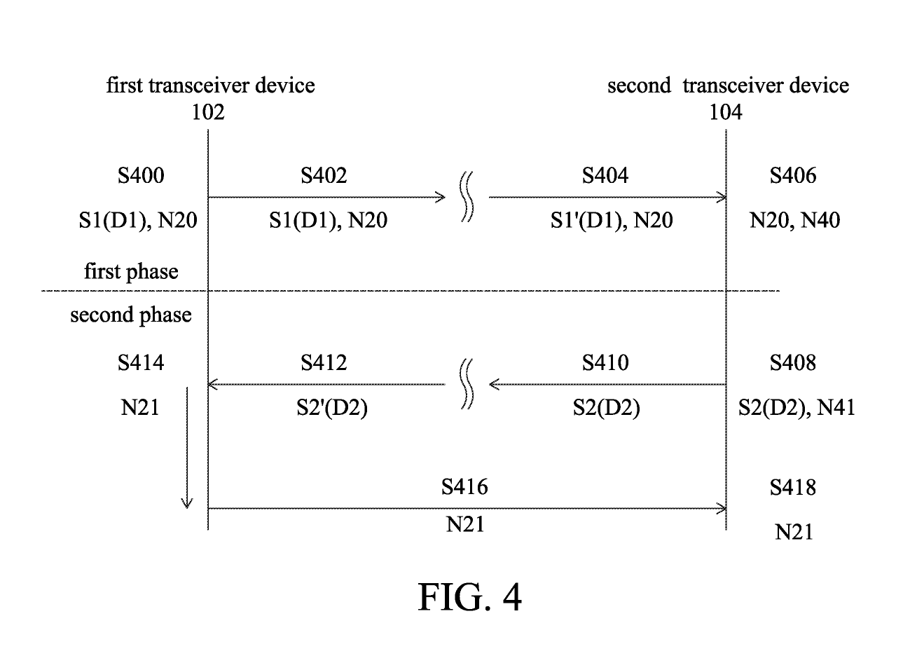

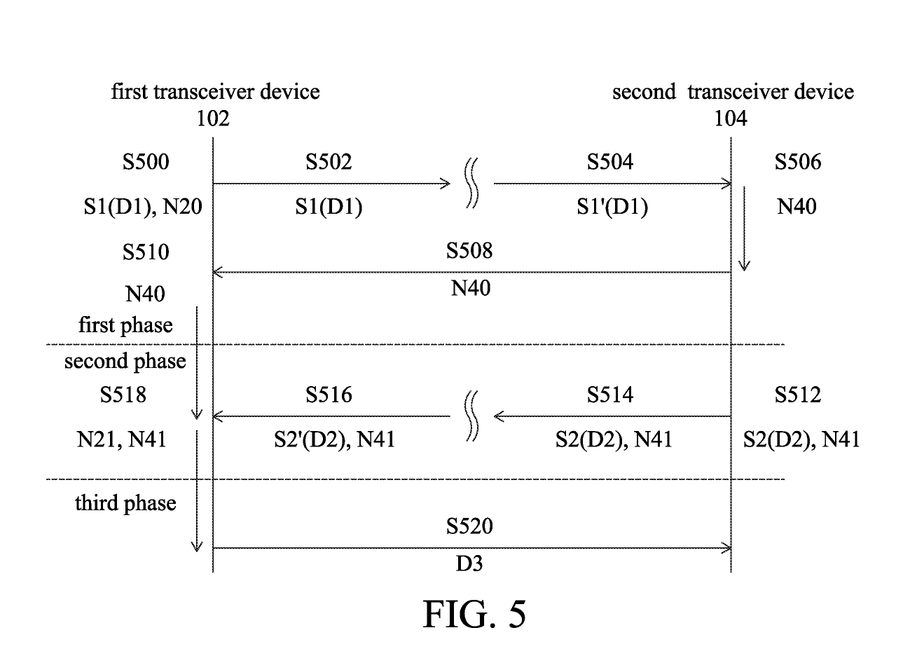

Subsequently, the method 200 continues with operation 222, in which a phase difference is obtained based on the first time difference ΔT1 and the second time difference ΔT2 by either the first transceiver device 102 or the second transceiver device, which will be described in detail with reference to FIGS. 4 and 5, respectively.

The method 200 proceeds with operation 224, in which the second transceiver device 104, based on the phase difference (i.e., based on the first time difference ΔT1 and the second time difference ΔT2), compensates the delayed source signal Ssource′ and provides the compensated signal Sm. In an embodiment, the second transceiver device 104, based on the first number N20, the second number N21, the third number. N40 and the fourth number N41, compensates the delayed source signal Ssource′.

In further detail, as illustrated in FIG. 3, the second time difference ΔT2 can also he expressed in equation (3) below.

ΔT1=ΔP1+ΔT2+ΔP2 (3)

As discussed in the text related to operation 216 and according to equations (1) and (2), the difference ΔP1 (or ΔP2) can be obtained. The difference ΔP1 (or ΔP2) serves as the phase difference. The second transceiver device 104, based on the difference ΔP1 (or ΔP2), compensates (or rebuilds) the delayed source signal Ssource′.

It should be noted that operations 202 through 208 in order are interchangeable with operations 210 through 216. Operations 210 through 216 could be performed prior to perform of operations 202 through 208.

In some prior approaches, there is no way to compensate the delayed source signal. Ssource′. As such, a signal provided by a transceiver device, such as the first transceiver device 104, is not synchronized with a signal provided another transceiver device, such as the second transceiver device 104, which would lead to undesirable effects. In contrast, by applying the method of the present disclosure to the system, a signal provided by the second transceiver device 104 is synchronized with that provided by the first transceiver device 102. Moreover, there is no need to provide two counters whose functions are completely the same. The method of the present disclosure can function effectively even with two counters having different functions. As a result, the present disclosure provides flexibility in the design of its two counters.

FIG. 4 illustrates interaction of the system 10 shown in FIG. 1 in accordance with some embodiments of the present disclosure. Referring to FIG. 4, operations S400 through S418 are similar to operations 202 through 216. Therefore, description of the same operation is omitted herein.

In a first phase, in operation S400, the first signal S1 including the first unique data D1 is provided, and the first timing (first number N20) is marked. In operation S402, the first transceiver device 102 transmits the first timing (first number N20) to the second transceiver device 104. In operation S406, the third timing (third number N40) is marked. Moreover, the second storage 124 stores the first timing (first number N20) and the third timing (third number N40).

In a second phase, in operation S412, the second transceiver device 104 provides the second signal S2; and the second storage 124 stores the fourth timing (fourth number N41). In operation S414, the second timing (second number N21) is marked. In operation S416, the first transceiver device 102 transmits the second timing (second number N21) to the second transceiver device 104.

The second transceiver device 104, based on the first timing, the second timing, the third timing and the fourth timing, obtains the phase difference. Accordingly, the second transceiver device 104, based on the phase difference, compensates the delayed source signal Ssource′. In the present embodiment, the phase difference is obtained by the second transceiver device 104.

FIG. 5 illustrates interaction of the system shown in FIG. 1 in accordance with some embodiments of the present disclosure. Referring to FIG. 5, operations 5500 through 5520 are similar to operations 202 through 216. Therefore, description of the same operation is omitted herein.

In a first phase, in operation S500, the first signal S1 is provided, and the first timing (first number N20) is marked. Moreover, the first transceiver device 102 stores the first timing (first number N20). In operation S502, the first transceiver device 102 does not transmit the first timing (first number N20) to the second transceiver device 104. In operation S506, the third timing (third number N40) is marked. In operation S508, the second transceiver device 104 transmits the third timing (third number N40) to the first transceiver device 102. In operation S510, the first storage 122 stores the third timing (third number N40).

In a second phase, in operation S512, the second signal S2 is provided, and the fourth timing (fourth number N41) is marked. In operation S514, the second transceiver device 104 transmits the fourth timing (fourth number N41) to the first transceiver device 102. In operation S518, the first transceiver device 102 receives the second delayed signal S2′ and the fourth timing (fourth number N41). Moreover, the second timing (second number N21) is marked. Additionally, the first storage 122 stores the fourth timing (fourth number. N41) and the second timing (second number N21).

In a third phase, the first transceiver device 102, based on the first timing, the second timing, the third timing and the fourth timing, obtains a phase difference. In operation S520, the first transceiver device 102 transmits the phase difference back to the second transceiver device 104. The second transceiver device 104 compensates the delayed source signal Ssource′ based on the phase difference. In contrast to the embodiment described and illustrated with reference to FIG. 4, in the present embodiment, the phase difference is obtained by the first transceiver device 102.

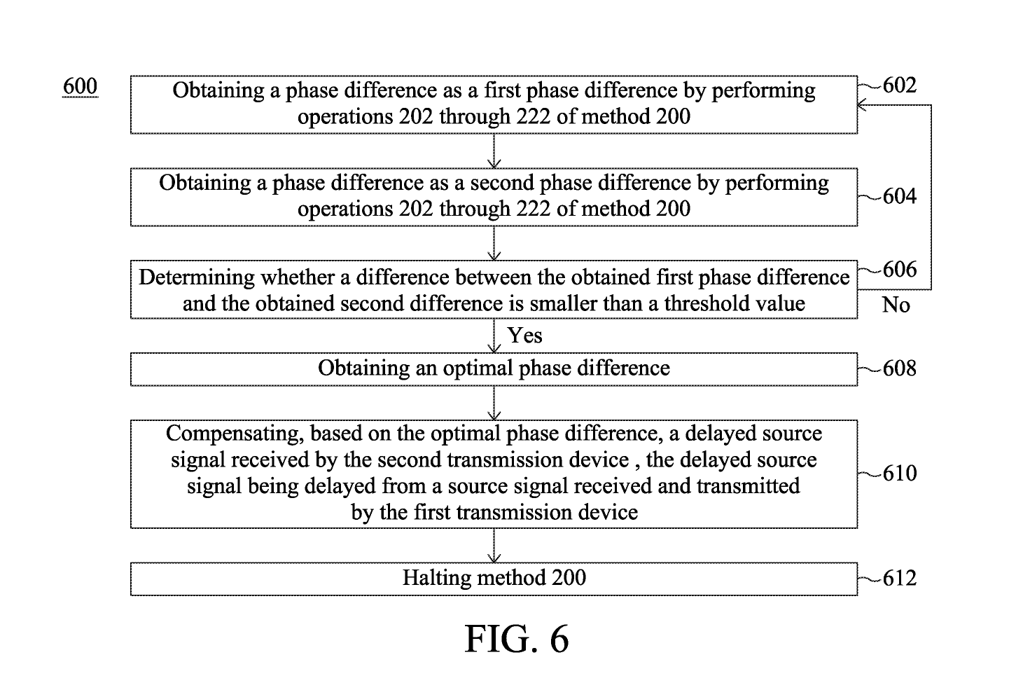

FIG. 6 is a flow chart illustrating a method 600 of compensating the source signal Ssource shown in FIG. 1 in accordance with some embodiments of the present disclosure. Referring to FIG. 6, the method 600 begins with operation 602, in which a phase difference is obtained as a first phase difference by performing operations 202 through 222 of method 200. Next, the method 600 continues with operation 604, in which a phase difference is obtained as a second phase difference by performing operations 202 through 222 of method 200.

Subsequently, the method 600 continues with operation 606, in which it is determined whether a difference between the obtained first phase difference and the obtained second difference is smaller than a threshold value. If not, operations 604 and 606 are repeated. If affirmative, in operation 608, an optimal phase difference is obtained. That is to say, when the phase difference presents convergence, the optimal phase difference is obtained. For example, it is assumed that the threshold value is 50 ns. When the difference is 30 ns, the optimal phase difference is obtained. In contrast, when the difference is 70 ns, which means the phase difference does not present convergence, operations 604 and 606 are repeated.

In operation 610, the second transceiver device 104 compensates, based on the optimal phase difference, the delayed source signal Ssource′ received by the second transceiver device 104.

In operation 612, the method 200 is halted. The first transceiver device 102 and the second transceiver device 104 can be restarted to perform operations of method 200 when the transceiver device 102 and the second transceiver device 104 receive an instruction to do so. For example, after halting method 200, a distance between the first transceiver device 102 and the second transceiver device 104 is changed, so the previous phase difference becomes no longer suitable for the current circumstance. In such circumstance, the first transceiver device 102 and the second transceiver device 104 can be restarted to perform operations of method 200.

Compared to some prior approaches, the present disclosure presents not only a method of compensating a source signal, but also a method for better compensating the source signal. Moreover, by applying the method of the present disclosure to the system, a signal provided by the second transceiver device 104 is synchronized with the first transceiver device 102. Additionally, there is no need to provide two counters whose function are completely the same. The method of the present disclosure can function effectively even with two counters having different functions. As a result, the present disclosure provides flexibility in the design of its two counters.

Some embodiments have one or a combination of the following features and advantages. In some embodiments, a method is provided. The method includes transmitting a first signal, including a first unique data, from a first transceiver device; marking a timing at which the first unique data in the first signal is exhibited as a first timing; receiving a second delayed signal, including a second unique data, at a first transceiver device, the second delayed signal being delayed from a second signal, and the second signal being transmitted from a second transceiver device; marking a timing at which the second unique data in the second delayed signal is exhibited as a second timing; and compensating, based on the first timing and the second timing, a delayed source signal received by the second transceiver device, the delayed source signal being delayed from a source signal received and transmitted by the first transceiver device.

In some embodiments, a method is provided. The method includes performing a first operation including an operation for obtaining a phase difference as a first phase difference, and obtaining a phase difference as a second phase difference; performing a second operation including the operation for obtaining a phase difference as a second phase difference; and repeating the first and second operations until a difference between the first phase difference and the second phase difference is smaller than a threshold value. The operation includes transmitting a first signal, including a first unique data, from a first transceiver device; marking a timing at which the first unique data in the first signal is exhibited as a first timing; receiving a second delayed signal, including a second unique data, at a first transceiver device, the second delayed signal being delayed from a second signal, and the second signal being transmitted from a second transceiver device; marking a timing at which the second unique data in the second delayed signal is exhibited as a second timing; and obtaining the phase difference based on the first timing, the second timing, the third timing and the fourth timing.

In some embodiments, a system is provided. The system includes a first transceiver device, a first counter and a second transceiver device. The first transceiver device is configured to receive and transmit a source signal, transmit a first signal including a first unique data, and receive a second delayed signal, including a second unique data, the second delayed signal being delayed from a second signal. The first counter is configured to mark a timing at which the first unique data in the first signal is exhibited as a first timing, and to mark a timing at which the second unique data in the second delayed signal is exhibited as a second timing. The second transceiver device is configured to transmit the second signal including the second unique data, receive a delayed source signal, the delayed source signal being delayed from the source signal, and compensate, based on the first timing and the second timing, the delayed source signal.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
transmitting a first signal, including a first unique data, from a first transceiver device;
marking a timing at which the first unique data in the first signal is exhibited as a first timing;
receiving a second delayed signal, including a second unique data, at a first transceiver device, the second delayed signal being delayed from a second signal, the second signal being transmitted from a second transceiver device;
marking a timing at which the second unique data in the second delayed signal is exhibited as a second timing; and
compensating, based on the first timing and the second timing, a delayed source signal received by the second transceiver device, the delayed source signal being delayed from a source signal received and transmitted by the first transceiver device.

2. The method of claim 1, wherein marking the timing at which the first unique data in the first signal is exhibited as the first timing includes counting to a first number by a first counter when the first unique data in the first signal is exhibited, and wherein marking the timing at which the second unique data in the second delayed signal is exhibited as the second timing includes counting to a second number by the first counter when the second unique data, in the second delayed signal, is exhibited.

3. The method of claim 2, wherein compensating, based on the first timing and the second timing, the delayed source signal received by the second transceiver device includes compensating, based on the first number and the second number counted by the first counter, the delayed source signal.

4. The method of claim 1, further comprising:
receiving a first delayed signal, including the first unique data, at a second transceiver device, the first delayed signal being delayed from the first signal;
marking a timing at which the first unique data in the first delayed signal is exhibited as a third timing;
transmitting the second signal, including the second unique data, from the second transceiver device;
marking a timing at which the second unique data in the second signal is exhibited as a fourth timing; and
compensating, based on the first timing and the second timing, the delayed source signal received by the second transceiver device further including compensating, based on the first timing, the second timing, the third timing and the fourth timing, the delayed source signal.

5. The method of claim 4, wherein marking the timing at which the first unique data in the first delayed signal is exhibited as the third timing includes counting to a third number by a second counter when the first unique data in the first delayed signal is exhibited, and wherein marking the timing at which the second unique data in the second signal is exhibited as the fourth timing includes counting to a fourth number by the second counter when the second unique data in the second signal is exhibited.

6. The method of claim 5, wherein compensating, based on the first timing and the second timing, the delayed source signal received by the second transceiver device includes compensating, based on the third number and the fourth number counted by the second counter, the first timing, and the second timing, the delayed source signal.

7. The method of claim 4, further comprising:
transmitting the first timing from the first transceiver device to the second transceiver device;
storing the third timing and the fourth timing at the second transceiver device;
transmitting the second timing from the first transceiver device to the second transceiver device; and
obtaining, based on the first timing, the second timing, the third timing and the fourth timing, a phase difference by the second transceiver device;
compensating, based on the first timing, the second timing, the third timing and the fourth timing, the delayed source signal including compensating, based on the phase difference, a delayed source signal by the second transceiver device.

8. The method of claim 4, further comprising:
storing the first timing and the second timing at the first transceiver device;
transmitting the third timing and the fourth timing from the second transceiver device to the :first transceiver device;
obtaining, based on the first timing, the second timing, the third timing and the fourth timing, a phase difference by the first transceiver device;
transmitting the phase difference from the first transceiver device to the second transceiver device; and
compensating, based on the first timing, the second timing, the third timing and the fourth timing, the delayed source signal including compensating, based on the phase difference, a delayed source signal by the second transceiver device.

9. A method, comprising:
performing a first operation including an operation for obtaining a phase difference as a first phase difference, and obtaining a phase difference as a second phase difference performing a second operation including the operation for obtaining a phase difference as a second phase difference; and
repeating the first and second operations until a difference between the first phase difference and the second phase difference is smaller than a threshold value,
wherein the operation includes:
transmitting a first signal, including a first unique data, from a first transceiver device;
marking a timing at which the first unique data in the first signal is exhibited as a first timing;
receiving a second delayed signal, including a second unique data, at a first transceiver device, the second delayed signal being delayed from a second signal, and the second signal being transmitted from a second transceiver device;
marking a timing at which the second unique data in the second delayed signal is exhibited as a second timing; and
obtaining the phase difference based on the first timing, the second timing, the third timing and the fourth timing.

10. The method of claim 9, further comprising:
obtaining an optimal phase difference when halting the first operation and the second operation; and
compensating, based on the optimal phase difference, a delayed source signal received by the second transceiver device, the delayed source signal being delayed from a source signal received and transmitted by the first transceiver device.

11. The method of claim 10, wherein marking the timing at which the first unique data in the first signal is exhibited as the first timing includes counting to a first number by a first counter when the first unique data in the first signal is exhibited, and marking the timing at which the second unique data in the second delayed signal is exhibited as the second timing includes counting to a second number by the first counter when the second unique data, in the second delayed signal, is exhibited.

12. The method of claim 11, wherein compensating, based on the optimal phase difference, a delayed source signal includes compensating, based on the first number and the second number counted by the first counter, the delayed source signal.

13. A system, comprising:
a first transceiver device configured to receive and transmit a source signal, transmit a first signal including a first unique data, and receive a second delayed signal, including a second unique data, the second delayed signal being delayed from a second signal;
a first counter configured to mark a timing at which the first unique data in the first signal is exhibited as a first timing, and mark a timing at which the second unique data in the second delayed signal is exhibited as a second timing;
a second transceiver device configured to transmit the second signal including the second unique data, receive a delayed source signal, the delayed source signal being delayed from the source signal, and compensate, based on the first timing and the second timing, the delayed source signal.

14. The system of claim 13, wherein the first transceiver device is independent of and separate from by the second transmission by a distance.

15. The system of claim 13, wherein the first counter is integrated in the first transceiver device.

16. The system of claim 13, wherein the first counter is further configured to count to a first number when the first unique data in the first signal is exhibited, and count to a second number when the second unique data, in the second delayed signal, is exhibited.

17. The system of claim 16, wherein the second transceiver device is configured to compensate, based on the first number and the second number counted by the first counter, the delayed source signal.

18. The system of claim 13, wherein:
the second transmission is configured to receive a first delayed signal including the first unique data, the first delayed signal being delayed from the first signal, transmit the second signal including the second unique data, and compensate, based on the first timing, the second timing, a third timing and a fourth timing, the delayed source signal;
the system further including:
a second counter configured to mark a timing at which the first unique data in the first delayed signal is exhibited as a third timing, and mark a timing at which the second unique data in the second signal is exhibited as a fourth timing.

19. The system of claim 18, wherein the second counter is configured to count to a third number when the first unique data in the first delayed signal is exhibited, and count to a fourth number when the second unique data in the second signal is exhibited.

20. The system of claim 19, wherein the second transceiver device is configured to compensate, based on the third number and the fourth number counted by the second counter, the first timing and the second timing, the delayed source signal.
